(19) United States
(12) Patent Application Publication
(10) Pub. No.: US 2025/0184124 A1
(43) Pub. Date: Jun. 5, 2025

(54) METHOD FOR CONTROL AND MANAGEMENT IN QUANTUM KEY DISTRIBUTION NETWORK AND APPARATUS FOR THE SAME

(71) Applicant: ELECTRONICS AND TELECOMMUNICATIONS RESEARCH INSTITUTE, Daejeon (KR)

(72) Inventors: Jeong Yun KIM, Daejeon (KR); Tae Yeon KIM, Daejeon (KR); Tae Sang CHOI, Daejeon (KR)

(73) Assignee: ELECTRONICS AND TELECOMMUNICATIONS RESEARCH INSTITUTE, Daejeon (KR)

(21) Appl. No.: 18/968,777

(22) Filed: Dec. 4, 2024

(30) Foreign Application Priority Data
Dec. 5, 2023 (KR) 10-2023-0174668
Jun. 27, 2024 (KR) 10-2024-0084858
Jun. 27, 2024 (KR) 10-2024-0084859
Jun. 27, 2024 (KR) 10-2024-0084860
Aug. 27, 2024 (KR) 10-2024-0114809
Dec. 3, 2024 (KR) 10-2024-0177181

(51) Int. Cl. H04L 9/08

(52) U.S. Cl. CPC H04L 9/0852; H04L 9/0819

(57) ABSTRACT

The present disclosure relates to a method for control and management in a quantum key distribution network and a device therefor. A method performed by a first apparatus in a QKDN according to one aspect of the present disclosure may include: transmitting, to a second apparatus, a first subscription message for subscribing to data collection; receiving, from the second apparatus, a first notification message for notifying the data collection; and transmitting an analysis result generated based on data collected through the first notification message.

### CROSS-REFERENCE TO RELATED APPLICATIONS

This application claims the benefit of earlier filing date and right of priority to Korean Application No. 10-2023-0174668, filed on Dec. 5, 2023, No. 10-2024-0084858, filed on Jun. 27, 2024, No. 10-2024-0084859, filed on Jun. 27, 2024, No. 10-2024-0084860, filed on Jun. 27, 2024, No. 10-2024-0114809, filed on Aug. 27, 2024, No. 10-2024-0177181, filed on Dec. 3, 2024, the contents of which are all hereby incorporated by reference herein in their entirety.

### TECHNICAL FIELD

The present disclosure relates to a method for control and management in a quantum key distribution network and a device therefor.

### BACKGROUND

The quantum key distribution network (QKDN) is expected to provide optimized support for various quantum key distribution (QKD) services. The key performance indicators (KPIs) of QKDN include optimal latency, accuracy, throughput, and key distribution availability. One of the challenges of QKDN is to ensure network performance and meet various quality of service (QOS)/quality of experience (QoE) requirements of various application scenarios.

In particular, as the number and variety of devices and other resources that constitute individual QKDNs continue to increase, QKDN control and management operations becomes more and more important to prevent inappropriate actions and improve Qos.

### SUMMARY

A technical object of the present disclosure is to provide a method and an apparatus for control and management in a QKDN.

In addition, A technical object of the present disclosure is to provide a method and an apparatus for a message format that can be commonly applied to control and management methods for various purposes.

The technical objects to be achieved by the present disclosure are not limited to the above-described technical objects, and other technical objects which are not described herein will be clearly understood by those skilled in the pertinent art from the following description.

A method performed by a first apparatus in a quantum key distribution network (QKDN) according to one aspect of the present disclosure may include: transmitting, to a second apparatus, a first subscription message for subscribing to data collection; receiving, from the second apparatus, a first notification message for notifying the data collection; and transmitting an analysis result generated based on data collected through the first notification message. The first subscription message and the first notification message may include information on an operation type indicating a type of a management operation and a correlation identifier uniquely indicating a correlation between the first apparatus and the second apparatus.

A first apparatus in a quantum key distribution network (QKDN) according to an additional aspect of the present disclosure may include: at least one processor; and at least one memory operably connected to the at least one processor and storing instructions that, when executed by the one or more processors, cause the apparatus to perform operations. The operations may include: transmitting, to a second apparatus, a first subscription message for subscribing to data collection; receiving, from the second apparatus, a first notification message for notifying the data collection; and transmitting an analysis result generated based on data collected through the first notification message. The first subscription message and the first notification message may include information on an operation type indicating a type of a management operation and a correlation identifier uniquely indicating a correlation between the first apparatus and the second apparatus.

At least one non-transitory computer-readable medium storing at least one instruction according to an additional aspect of the present invention, wherein the at least one instruction executable by at least one processor may control a first apparatus operating in a quantum key distribution network (QKDN) to: transmit, to a second apparatus, a first subscription message for subscribing to data collection; receive, from the second apparatus, a first notification message for notifying the data collection; and transmit an analysis result generated based on data collected through the first notification message. The first subscription message and the first notification message may include information on an operation type indicating a type of a management operation and a correlation identifier uniquely indicating a correlation between the first apparatus and the second apparatus.

Preferably, an acceptance message for accepting a subscription to the data collection may be received from the second apparatus.

Preferably, a second subscription message for subscribing to an analysis report may be received from the second apparatus or a third apparatus, and a second notification message for notifying of the analysis report may be transmitted to the second apparatus or the third apparatus. The analysis result may be transmitted through the second notification message.

Preferably, the second subscription message and the second notification message may include information on an operation type and a correlation identifier

Preferably, the third apparatus may perform a function of orchestrating management for multiple layers.

Preferably, when the operation type indicates fault management, the analysis result may include a link status generated based on quantum key distribution (QKD) link diagnostic information or a key relay fault generated based on key manage (KM) relay diagnostic information.

Preferably, when the operation type indicates accounting management, the analysis result may include a report for a charging process generated based on metered accounting information.

Preferably, when the operation type indicates configuration management, the analysis result may include a report including a topology and resource inventory.

Preferably, when the operation type indicates performance management, the analysis result may include a report generated by analyzing performance information.

Preferably, when the operation type indicates security management, the analysis result may include a report generated by analyzing security information.

According to an embodiment of the present invention, service quality and performance of a QKDN can be improved by utilizing a control and management procedure.

In addition, according to the embodiment of the present disclosure, the safe, stable, efficient and robust operation and service of QKDN can be realized.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates an architecture model of a QKDN to which the present invention can be applied.

FIG. 2 illustrates a fault management procedure for QKD link failure in a QKDN according to an embodiment of the present invention.

FIG. 3 illustrates a fault management procedure for a key relay failure in a QKDN according to an embodiment of the present invention.

FIG. 4 illustrates an accounting management procedure in a QKDN according to an embodiment of the present invention.

FIG. 5 illustrates a configuration management procedure in a QKDN according to an embodiment of the present invention.

FIG. 6 illustrates a performance management procedure in a QKDN according to an embodiment of the present invention.

FIG. 7 illustrates a security management procedure in a QKDN according to an embodiment of the present invention.

FIG. 8 illustrates a control and management method in a QKDN according to an embodiment of the present invention.

FIG. 9 is a block diagram of an apparatus for control and management operating in a QKDN according to an embodiment of the present invention.

### DETAILED DESCRIPTION

Since the present disclosure can make various changes and have various embodiments, specific embodiments will be illustrated in the drawings and described in detail in the detailed description. However, this is not intended to limit the present disclosure to specific embodiments, and should be understood to include all changes, equivalents, and substitutes included in the feature and technical scope of the present disclosure. Similar reference numbers in the drawings refer to identical or similar functions across various aspects. The shapes and sizes of elements in the drawings may be exaggerated for clearer explanation. For a detailed description of the exemplary embodiments described below, refer to the accompanying drawings, which illustrate specific embodiments by way of example. These embodiments are described in sufficient detail to enable those skilled in the art to practice the embodiments. It should be understood that the various embodiments are different from one another but are not necessarily mutually exclusive. For example, specific shapes, structures and characteristics described herein with respect to one embodiment may be implemented in other embodiments without departing from the spirit and scope of the disclosure. Additionally, it should be understood that the position or arrangement of individual components within each disclosed embodiment may be changed without departing from the spirit and scope of the embodiment. Accordingly, the detailed description that follows is not to be intended in a limiting sense, and the scope of the exemplary embodiments is limited only by the appended claims, together with all equivalents to what those claims assert if properly described.

In the present disclosure, terms such as first, second, etc. may be used to describe various components, but the components should not be limited by the terms. The above terms are used only for the purpose of distinguishing one component from another. For example, a first component may be referred to as a second component, and similarly, the second component may be referred to as a first component without departing from the scope of the present disclosure. The term “and/or” includes any of a plurality of related stated items or a combination of a plurality of related stated items.

When a component t of the present disclosure is referred to as being “connected” or “accessed” to another component, it may be directly connected or connected to the other component, but other components may exist in between. It must be understood that it may be possible. On the other hand, when it is mentioned that a component is “directly connected” or “directly accessed” to another component, it should be understood that there are no other components in between.

The components appearing in the embodiments of the present disclosure are shown independently to represent different characteristic functions, and do not mean that each component is comprised of separate hardware or one software component. That is, each component is listed and included as a separate component for convenience of explanation, and at least two of each component can be combined to form one component, or one component can be divided into a plurality of components to perform a function, and each of these components can be divided into a plurality of components. Integrated embodiments and separate embodiments of the constituent parts are also included in the scope of the present disclosure as long as they do not deviate from the essence of the present disclosure.

The terms used in this disclosure are only used to describe specific embodiments and are not intended to limit the disclosure. Singular expressions include plural expressions unless the context clearly dictates otherwise. In the present disclosure, terms such as “comprise” or “have” are intended to designate the presence of features, numbers, steps, operations, components, parts, or combinations thereof described in the specification, but are not intended to indicate the presence of one or more other features. It should be understood that this does not exclude in advance the possibility of the existence or addition of elements, numbers, steps, operations, components, parts, or combinations thereof. In other words, the description of “including” a specific configuration in this disclosure does not exclude configurations other than the configuration, and means that additional configurations may be included in the scope of the implementation of the disclosure or the technical feature of the disclosure.

Some of the components of the present disclosure may not be essential components that perform essential functions in the present disclosure, but may simply be optional components to improve performance. The present disclosure can be implemented by including only essential components for implementing the essence of the present disclosure, excluding components used only to improve performance, and a structure that includes only essential components excluding optional components used only to improve performance is also included in the scope of rights of this disclosure.

Hereinafter, embodiments of the present disclosure will be described in detail with reference to the drawings. In describing the embodiments of the present specification, if it is determined that a detailed description of a related known configuration or function may obscure the gist of the present specification, the detailed description will be omitted, and the same reference numerals will be used for the same components in the drawings. Redundant descriptions of the same components are omitted.

The following disclosure may be referenced to interpret background technology, term definitions, abbreviations, etc. related to the present invention.
[ITU-T Y.3111] Recommendation ITU-T Y.3111 (2017), IMT-2020 network management and orchestration framework.
[ITU-T Y. 3800] Recommendation ITU-T Y.3800 (2019), Overview on networks supporting quantum key distribution.
[ITU-T Y. 3801] Recommendation ITU-T Y.3801 (2020), Functional requirements for quantum key distribution networks.
[ITU-T Y. 3802] Recommendation ITU-T Y.3802 (2020), Quantum key distribution networks-Functional architecture.
[ITU-T Y. 3803] Recommendation ITU-T Y. 3803 (2020), Quantum key distribution networks-Key management.
[ITU-T M. 3400] Recommendation ITU-T M.3400 (2000), TMN management functions.

A quantum key distribution network (QKDN) can support various quantum key distribution services.

In order to realize a secure, stable, efficient, and robust operation and service of a quantum key distribution (QKD) network, the present invention proposes a QKDN control and management method.

The following terms that may be used in this disclosure are defined as follows:
Key data: refers to random bit strings, which are used as a cryptographic key.
Key life cycle: refers to a sequence of steps that a key undergoes from its reception by a key manager (KM) through its use in a cryptographic application and until deletion or preservation depending on the key management policy.
Key management: refers to all activities performed on keys during their life cycle starting from their reception from the quantum layer, storage, formatting, relay, synchronization, authentication, to supply to a cryptographic application and deletion or preservation depending on the key management policy.
Key management agent (KMA): refers to a functional element to manage keys generated by one or multiple quantum key distribution (QKD) modules in a QKD node (trusted node). Here, KMA may acquire keys from one or multiple QKD modules, synchronizes, resizes, formats, and stores them. In addition, it may also relay keys KMA links.
Key management agent-key (KMA-key): refers to key data stored and processed in a key management agent (KMA) and securely shared between a KMA and a matching KMA.
Key manager (KM): refers to a functional module located in a quantum key distribution (QKD) node to perform key management in the key management layer.
Key manager link: refers to a communication link connecting key managers (KMs) to perform key management.
Key relay: refers to a method to share keys between arbitrary quantum key distribution (QKD) nodes via intermediate QKD node(s).
Key supply: refers to a function providing keys to cryptographic applications.
Key supply agent (KSA): refers to a functional element to supply keys to a cryptographic application, being located between a key management agent (KMA) and the cryptographic application. Here, application interfaces for cryptographic applications may be installed into the key supply agent (KSA). The KSA may synchronize keys and verify their integrity via a KSA link before supplying them to the cryptographic application.
Key supply agent-key (KSA-key): refers to key data stored and processed in a key supply agent (KSA), and securely shared between a KSA and a matching KSA.
Quantum key distribution module (QKD module): refers to a set of hardware and software components that implements cryptographic functions and quantum optical processes, including quantum key distribution (QKD) protocols, synchronization, distillation for key generation, and is contained within a defined cryptographic boundary. Here, a QKD module may be connected to a QKD link, acting as an endpoint module in which a key is generated. These are two types of QKD modules, namely, the transmitters (QKD-Tx) and the receivers (QKD-Rx).
Quantum key distribution link (QKD link): refers to a communication link between two QKD modules for operating QKD. Here, the QKD link may include a quantum channel for quantum signal transmission and a classical channel used to exchange information for synchronization and key distillation.
Quantum key distribution network (QKDN): refers to a network comprised of two or more quantum key distribution (QKD) nodes connected through QKD links. Here, a QKDN may allow sharing keys between the QKD nodes by key relay when they are not directly connected by a QKD link.
Quantum Key Distribution Network Controller (QKDN controller): refers to a functional module located in the QKD network control layer that controls a QKD network.
Quantum key distribution network manager (QKDN manager): refers to a functional module located in a QKD network management layer that monitors and manages a QKD network.
Quantum key distribution node (QKD node): refers to a node that includes one or more QKD modules that are protected from intrusion and attacks by unauthorized parties. Here, a QKD node may include a key manager (KM).
User network: refers to a network in which cryptographic applications consume keys supplied by a quantum key distribution (QKD) network. Here, in the present disclosure, “key” means “symmetric random bit strings” produced by QKDN.

The abbreviations for terms that can be used in this disclosure are defined as follows.
BSS: Business Support System
CDR: Charging Data Record
FCAPS: Fault, Configuration, Accounting, Performance and Security
ID: Identifier
IMT: International Mobile Telecommunications
IP: Internet Protocol
KM: Key Manager
KMA: Key Management Agent
KMLM: Key Management Layer Management
KSA: Key Supply Agent
OSS: Operation Support System
QBER: Quantum Bit Error Rate
QCLM: QKDN Control Layer Management
QKD: Quantum Key Distribution
QKDN: Quantum Key Distribution Network
QLM: Quantum Layer Management
QOS: Quality of Service
TMN: Telecommunications Management Network
VPN: Virtual Private Network
XLMO: Cross Layer Management and Orchestration

Hereinafter, the present invention proposes a method for control and management in QKDN based on a subscription-notification information exchange scheme.

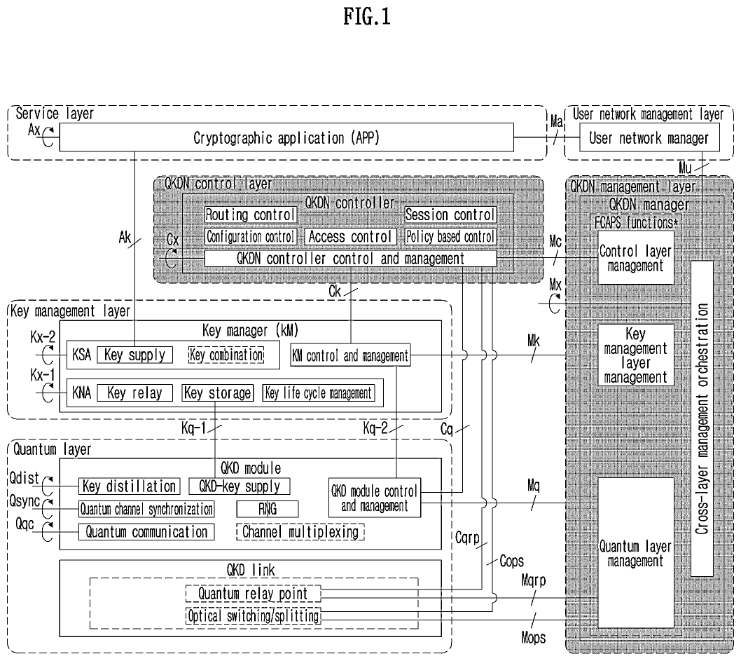

FIG. 1 illustrates an architectural model for a QKDN to which the present invention can be applied.

Referring to FIG. 1, an entire network may include a user network and a QKDN. Here, a QKDN may be defined/configured separately from a user network, and may be defined/configured including a user network. Hereinafter, for convenience of explanation, a QKDN is described assuming that it is separated from a user network.

A user network may include applications such as an encryptor and a decryptor. A QKDN may include QKD nodes including a QKD module, a QKD link connecting the QKD node, a relay point (key relay), and an optical switch/splitter.

A user network may include a service layer and a user network management layer. A service layer may use shared key pairs provided by a QKDN and perform secure communication. A cryptographic application of a service layer may utilize shared key pairs provided by a QKDN and perform encrypted communication between remote parties. Three representative cryptographic applications of a service layer may include a point-to-point application, a point-to-multipoint application, and a multipoint-to-multipoint application. A user network management layer may perform FACPS (fault, configuration, accounting, performance, security) functions of a user network.

The QKDN to which the present invention can be applied can support control and management specific functions (e.g., path calculation for routing control, session control including access traffic steering/switching/splitting for session control, quality of service (Qos) and charging policy control, FCAPS management for each layer).

In addition, the QKDN can support control and management reference points between control and management functional components and between a control and management functional component and a component of other layers.

In addition, the QKDN can support control and management orchestration functions of multi-layers. For this purpose, the QKDN management layer can include multiple functional components responsible for multi-layer (quantum layer, key management layer, QKDN control layer) and cross-layer management orchestration.

In addition, the QKDN can support interworking functions with external management systems, particularly user network management systems, management capability exposure functions, etc.

FIG. 1 illustrates functional components and reference points related to QKDN control and management in QKDN. Each layer includes a layer-specific control and management function associated with a corresponding management function of the QKDN management layer. Each layer-specific control and management function provides a management agent capability between each layer management function of the QKDN manager and the corresponding layer functions. The cross-layer management orchestration function provides orchestration capability between multiple layer management functions.

Here, the reference points, Cx, Ck, Cq, Cops, and Carp are defined as standard interfaces between the QKDN controller(s) and the functional components under control for the purpose of QKDN control.

In addition, the reference points, Mq, Mqrp, Mops, Mk, Mc, Mx, and Mu are defined as standard interfaces between the QKDN manager and the functional components under management for the purpose of QKDN management.

A QKDN may include various entities such as a QKDN control layer, a Key Management Layer, a Quantum Layer, and a QKDN management layer.

Functional elements of a Quantum Layer include a QKD link and a QKD module, and can be enabled to easily communicate with a QKDN controller. Parameters of a quantum layer, such as a quantum key generation rate, a transmit power, and a receive power, can be adjusted by a QKDN controller of a QKDN control layer. Functions of a QKD link can include, for example, an optical switching/splitting function, a quantum relay function, etc. Functions of a QKD module can include, for example, a key distillation function, a quantum channel synchronization function, a quantum communication, a QKD key supply function, a random number generation (RNG) function, a channel multiplexing function, and a QKD module control and management function, etc.

Functional elements of a Key Management Layer may include a Key Manager (KM). A KM includes a key supply agent (KSA), a key management agent (KMA), and a key management control and management (KM control and management) block, and may exchange messages for control and management with a QKDN controller. Functions of a KMA may include, for example, a key relay function, a key storage function, and a key life cycle management function, etc. Functions of a KSA may include, for example, a key supply function, and may further include a key combination function.

Hereinafter, the QKDN control layer is described in detail.

In order to realize the secure, stable, efficient and robust operation and service of QKDN, the functional elements of the QKDN control layer may include the QKDN controller. The QKDN controller controls the quantum layer, the key management layer, and supports the functions of the QKDN management layer and the service layer. The QKDN controller communicates control information with the KM, QKD module and QKD link respectively through the reference points, Ck, Cq, Corp and Cops. In the distributed architecture, the QKD controller communicates with each other through the reference point Cx.

The QKDN controller communicates management information with the QKDN manager through the reference point Mc. This function supports the FCAPS of QKDN.

The QKDN controller does not deal with the key itself. The key is directly provided from the KM to a cryptographic application through the reference point Ak.

Functions of a QKDN controller may include, for example, a routing control function, a configuration control function, an access control function, a session control function, a policy-based control function, and a QKDN controller control and management function, etc.

a. Routing Control Function

The routing control function provides an appropriate key relay path between two endpoints of the KM in the key management layer. The routing control function also performs rerouting of the key relay according to the status of the key management layer and/or the quantum layer to ensure the continuous operation of the key supply/key relay.

For this purpose, the QKDN controller has the following functions:
The function to manage the routing table including the necessary information on the QKD node address and the KM identifier.
The function to acquire information on the key consumption rate and the residual amount of keys from the KM, the QKD link parameters from the QKD module, and the QKDN topology information from the QKDN manager.
The function to support the optimization of the key relay route in the entire QKDN by the QKDN manager, which monitors the overall status of the quantum layer and the key management layer and registers and updates it in the database.

The QKDN controller performs provisioning and rerouting of key relay paths in the following manner:

### i) Key Relay Path Provisioning

Two endpoint KMs inform QKDN controller of the amount of keys required by two endpoint encryption applications.

The QKDN controller analyzes the status of key management layer, especially the key consumption rate and the key remaining number of KMs, along with the candidates for key relay routes.

Then, the QKDN controller finds and provisions an appropriate key relay route.

### ii) Key Relay Rerouting

There are two typical cases where rerouting is performed:

### Case 1: Key Management Layer Attributed

The residual amount of keys in the KM(s) of the relay node(s) runs short below a threshold.
A fault is detected in the KM(s) of the relay node(s) and in the KM link(s) connected to the relay node(s).

### Case 2: Quantum Layer Attributed

The quantum bit error rate (QBER) increases beyond the threshold in a specific QKD link connected to the relay node(s).
A fault is detected in the QKD module(s) of the relay node(s).

In any case, it is desirable to disable the faulty KM, KM link, QKD module, and QKD link, and the QKDN manager needs to apply appropriate cause analysis and countermeasures.

b. Configuration Control Function

The configuration control function performs the following functions.
The function to acquire control-related configuration information for the QKD module and QKD link of the quantum layer and the KM and KM link of the key management layer.
The function to control the status of these components (in service, out of service, standby or reserved).
The function to reconfigure the QKD link and KM link when an alarm or fault diagnosis is notified.

In particular, the alarm and fault diagnosis of the QKD link include an increase in OBER, which means that eavesdropping is launched against a quantum channel or the quantum channel loss has increased. The reconfiguration of the QKD link is performed by controlling the modules of the optical switch/splitter, the quantum relay point, or by introducing a backup quantum channel into service.

Reconfiguring a KM link is mainly about replacing faulty classical channels with new ones to provide a service, which is actually the same as the existing communication network.

c. Policy-Based Control Function

The policy-based control function controls QKDN according to the charging policy for Qos, key management, and encryption applications. Policy decision-making is performed with the help of the QKDN manager.

d. Access Control Function

The access control function provides the function to verify the requested identity of the functional component under the control and support of the QKDN controller and restrict the functional component to pre-authorized activities or roles. The verified identity and the corresponding authority/role provide the basis for the secure operation and service of QKDN.

The access control function has an access control repository of QKD nodes, QKD modules, KMs, and cryptographic applications. The access control repository also includes the authorized roles, access rights, and priorities of these functional components based on the enforced policies. Based on this repository, the access control performs the following functions:
The function to register and delete the ID of the functional component.
The function to issue a certificate to a registered functional component.
The function to perform authentication between the QKDN controller and the functional component by referring to the certificate.
The function to support authentication between the functional components according to the certificate and the access control repository.
   e. Session Control Function

The session control function supports the KMA to establish end-to-end keys and/or the Key Provisioning Agent (KSA) to provide keys to cryptographic applications at the service layer of the user network. Based on the charging policy enforced by the policy-based control function, the KMA controls the session according to the key management policy, and the KSA controls the session procedure of the key provisioning service flow for multiple cryptographic applications.

Hereinafter, the following describes the QKDN management layer in detail.

Elements of a QKDN management layer can communicate with a QKDN controller to obtain configuration and management information. A QKDN management layer includes a QKDN manager, and functions of a QKDN manager may include a FACPS (fault, configuration, accounting, performance, security) functions and a cross-layer management orchestration function. FACPS functions may include a Control layer Management function, a Key management layer Management function, a Quantum layer Management function, etc.

Hereinafter, the FCAPS management functions for QKDN are described in more detail.

a. Common Management Functions

The QKDN-specific aspects of FCAPS arise from the restriction of quantum layer configuration due to the point-to-point nature of QKD and the security issues due to the nature of the key configuration infrastructure. Therefore, these aspects are mainly related to the quantum layer and the key management layer. Considering these aspects, the common FCAPS management functions in the quantum layer, key management layer, and QKDN control layer of QKDN are as follows:

The QKDN manager supports the following fault management functions:
The QKDN manager monitors QKD link failures and supports QKD module to take appropriate recovery actions, including QKD link reconfiguration and key relay path rerouting.
The QKDN manager provides fault detection and root cause analysis/diagnosis functions for quantum layer, key management layer, and QKDN control layer.
The QKDN manager performs decision and generation of fault resolution policies and interacts with each layer to perform recovery actions.
The QKDN manager discovers management resources and functions of each layer and bootstraps them to prepare for work according to the bootstrapping policy.

The QKDN manager supports the following configuration management functions:
The QKDN manager provisions and configures the resources managed in each layer.
The QKDN manager manages the configuration status of each layer.
The QKDN manager manages the network topology of each layer.
The QKDN manager performs inventory management for all QKDN resources in each layer.
The QKDN manager manages the life cycle of resource repositories in each layer (e.g., creation, storage, search, modification, removal, etc.).

The QKDN manager supports the following accounting management functions:
The QKDN manager measures resource usage data of each layer (e.g. quantum key usage of quantum layer) and generates accounting policies for charging.

The QKDN manager supports the following performance management functions:
The QKDN manager collects performance data and status of each layer and registers and updates the performance database.
The QKDN manager analyzes the performance of the collected data and generates a performance report.
The QKDN manager manages key provisioning service policies.

The QKDN manager supports the following security management functions:
The QKDN manager collects management information including metadata, event logs, and audit trails at each layer to detect security anomalies.
The QKDN manager supports key lifecycle management by KM while ensuring key traceability using a log database.
QKDN manager has a root certificate authority that issues root certificates to QKDN controller. QKDN manager supports QKDN controller for access control.
QKDN manager manages key management policies and transmits them to QKDN controller.
   b. Layer-Specific Management Functions

The QKDN manager provides FCAPS management functions for each QKDN layer (i.e., quantum layer, key management layer, and QKDN control layer). Therefore, the QKDN manager includes three layer-specific functions:
quantum layer management (QLM) function;
key management layer management (KMLM) function;
QKDN control layer management (QCLM) function.

The above three functions perform FCAPS management. In addition, for coordination management, cross-layer management, and external management issues, the management functions of the three layers can be orchestrated through:
Cross-layer management orchestration (XLMO) function,

Here, XIMO also supports user network management.

The following describes the management functions specific to each layer in more detail.

### i) QLM Functions

The quantum layer-specific FCAPS management functions are as follows:
The QKDN manager detects attempts to eavesdrop on quantum channels.
The QKDN manager collects and analyzes QKD-specific performance information such as key generation rates.
The QKDN manager manages the availability and reliability of quantum key distribution based on the redundancy of QKD links provided by the quantum layer.
QKDN manager supports metadata abstraction to map device-dependent data into device-independent data for device interoperability at the quantum layer.

### ii) KMLM Function

The key management layer specific FCAPS management functions are as follows:
The QKDN manager collects and analyzes the amount of keys available in KM for key relay, key provisioning service, and key life cycle management.
   iii) QCLM Function

The QKDN control layer specific FCAPS management functions are as follows:
QKDN manager supports QKDN controller for routing and rerouting of key relay, including instructions for policies and rules that occur due to faults or performance degradation.
If QKDN supports key relay as a configuration management function, the QKDN manager supports QKDN controller to provision routing and re-routing of key relay.
   c. XLMO function

XIMO orchestrates the management functions of the quantum layer, key management layer and QKDN control layer. It also orchestrates control and management functions. It also exchanges management information with external management entities. The user network management layer corresponds to an external management entity from the perspective of QKDN management. If necessary, it can interact and orchestrate with other management entities (e.g., operator's OSS, BSS, etc.).

The XIMO supports the following management functions.

### i) Orchestration for Cross-Layers Management

The XIMO provides management coordination between the quantum layer, key management layer, and QKDN control layer.
The XLMO provides management orchestration between the QKDN control layer and QKDN management layer to enable the QKDN controller to take necessary actions in abnormal situations (e.g., faults, performance degradation, security attacks, etc.).
For the entire QKDN provisioning, the XLMO divides the provisioning information into three types of initialization and configuration information for the three layers (i.e., quantum layer, key management layer, and QKDN control layer), and performs provisioning tasks for each layer in order.

### ii) Orchestration for External Management

The XLMO provides management orchestration with external management systems, especially user network management systems, and provides management orchestration between two QKDN managers within the same QKDN.
The XLMO collects, stores, and displays the topology of QKDN.
The XLMO provides QKDN resource usage status.
The XLMO supports QKDN resource provisioning requested by user network managers.
The XLMO interacts with user network managers on behalf of users.

Meanwhile, information exchange between components within the QKDN architecture can be performed through logical interfaces between layers, functional elements, and entities, which are defined as reference points.

For example, the Mx reference point supports management request/response between the XIMO function of two QKDN managers. The Mx reference point operates as an intra-domain reference point.

The Mx reference point provides the following functions for XLMO:
Requesting provisioning status of QKDN management layer functions;
Requesting performance of QKDN management layer functions;
Requesting alarm information of QKDN management layer functions;
Responding and/or sending asynchronous notifications for QKDN management operation requests from other QKDN manger(s);
Requesting/responding QKDN management operation to external management entities other than other QKDN manager(s).

The information components exchanged through the Mx reference point can be classified as shown in Table 1.

TABLE 1

| Information component | Description |
|---|---|
| QKDN management layer | Description of QKDN management layer |
| resource Description | resource for management purpose |
| QKDN management layer | Identifier of QKDN management layer |
| managed resource ID | managed resource of interests for |
| | management |
| QKDN management layer | Description of performance information |
| Performance Description | of the QKDN management layer managed |
| | resource |
| QKDN management layer | Indication of type of performance |
| performance information | information (e.g., key relaying delay, |
| type | key data loss, etc.) |
| QKDN management layer | Identifier of target managed object for |
| performance information | collecting performance information |
| target managed object ID | |
| QKDN management layer | Value of the performance information |
| performance information | collected |
| value | |
| QKDN management layer | Description of alarm information of the |
| Alarm Description | QKDN management layer managed resource |
| QKDN management layer | Indication of type of QKDN management |
| alarm type | layer alarm associated with fault or |
| | anomalous event |
| QKDN management layer | Identifier of a QKDN management layer |
| alarm ID | alarm associated with fault or anomalous |
| | event |
| QKDN management layer | Identifier of a source of a QKDN |
| alarm source ID | management layer alarm |
| QKDN management layer | Value of the QKDN management layer |
| alarm value | alarm |

Hereinafter, the procedure of control, management, and orchestration based on the subscription-notification information exchange method within QKDN proposed in the present invention is described in detail.

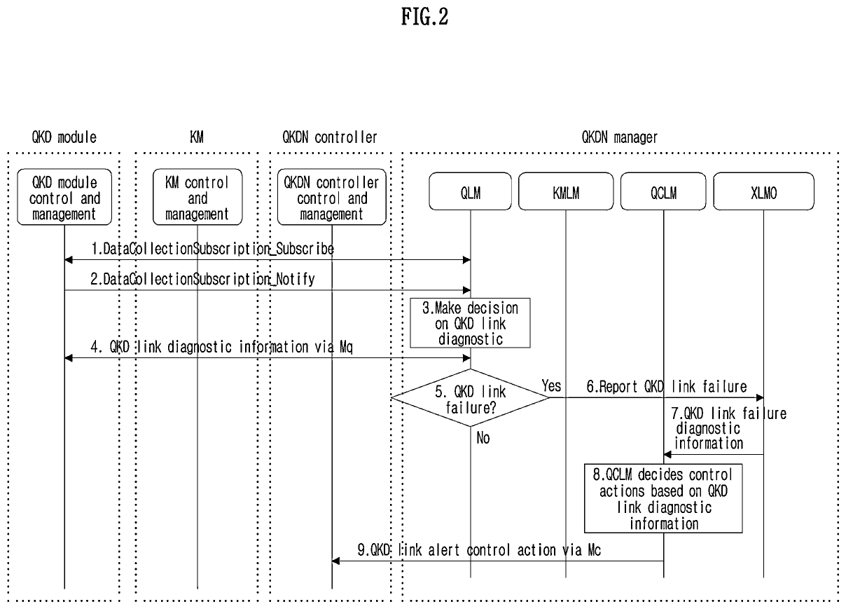

FIG. 2 illustrates a fault management procedure for QKD link failure in a QKDN according to one embodiment of the present invention.

FIG. 2 illustrates a fault management procedure for QKD link failure in a QKD module.

1. The QLM subscribes to data collection by invoking the DataCollectionSubscription Subscribe operation to the QKD module control and management function through the Mq reference point. That is, the QLM transmits a subscription message for subscribing to data collection to the QKD module control and management function. Here, if the subscription is accepted, the QKD module control and management function can respond with OK (i.e., respond with an acceptance message for accepting the subscription to data collection).

The information components that can be provided by the QLM to the QKD module control and management function are as shown in Table 2. In other words,

DataCollectionSubscription Subscribe invoked by the QLM (i.e., a subscription message for subscribing to data collection transmitted by the QLM) can include at least one information component among the information components exemplified in Table 2.

For example, the DataCollectionSubscription Subscribe (i.e., a subscription message for subscribing to data collection) may include an information component for an operation type (TypeOperation) and an information component for a correlation identifier (Correlation Identifier). The information component for an operation type (TypeOperation) indicates a type of management operation. In the case of the example in FIG. 2, the TypeOperation may indicate fault management. In addition, in Table 2, the information component for a correlation identifier (Correlation Identifier) uniquely indicates a correlation between a consumer (QLM in FIG. 2) and a producer (QKD module control and management function in FIG. 2). In the case of the example in FIG. 2, the Correlation Identifier may uniquely indicate the correlation between the QLM and the QKD module control and management function.

Table 2 illustrates the information components for the DataCollectionSubscription operation.

TABLE 2

| Information | | |
|---|---|---|
| component | Description | Example |
| Consumer | A unique identifier for a function of | QCLM, KMLM, |
| identifier | requesting performance management | QLM |
| | operation (e.g., | |
| | DataCollectionSubscription_Subscribe). | |
| Producer | A unique identifier for a function of | QKDN control, |
| identifier | responding performance management | key management |
| | operation (e.g., | layer, quantum |
| | DataCollectionSubscription_Notify). | layer |
| Globally unique | A set of IP address information used for | QKDN control, |
| IP address | locating the network in which each layer | key management |
| information | control and management function is | layer, quantum |
| (Optional) | requesting the management operations. | layer |
| Unique IP | The IP address for identifying each layer | QCLM, KMLM, |
| address | control and management function. | QLM |
| Address realm | The addressing domain of the IP address | |
| | (e.g., Subnet prefix or VPN ID) | |
| Management | A layer for operating performance | QKDN control, |
| operation layer | management | key management |
| | | layer, quantum |
| | | layer |
| Management | The indication of the importance of a | QCLM, KMLM, |
| operation | management operation request. It can be | QLM |
| request priority | used for processing simultaneous | |
| (Optional) | requests by each layer management | |
| | functional component (QCLM, KMLM, & QLM) | |
| | based on the priority level. | |
| TypeNotify | The indication of the type of notifying | QCLM, KMLM, |
| (Optional) | an event (e.g., time interval, | QLM |
| | periodicity, maximum number, minimum | |
| | number, etc.). | |
| | It is an information component of | |
| | DataCollectionSubscription_Subscribe. | |
| TypeOperation | The indication of the type of the | QCLM, KMLM, |
| | management operation (e.g., | QLM |
| | configuration, performance, security). | |
| | It is an information component of | |
| | DataCollectionSubscription_Subscribe. | |
| Management | Indication of the result for a management | QKDN control, |
| operation | operation request. | key management |
| request result | | layer, quantum |
| | | layer |
| Correlation | A unique identifier for correlation | QKDN control, |
| Identifier | between a consumer and a producer. | key management |
| | | layer, quantum |
| | | layer |
| EventNotify | Allows each layer to send notifications | QKDN control, |
| | to the layer specific management support | key management |
| | functional component in QKDN manager for | layer, quantum |
| | an event that may need to take an | layer |
| | appropriate action for requested | |
| | management operations. | |
| | It is an information component of | |
| | DataCollectionSubscription_Notify. | |

2. The QKD module control and management function notifies the QLM with data collection by invoking the DataCollectionSubscription_Notify operation based on the subscription of data collection in step 1. That is, the QKD module control and management function transmits a notification message to the QLM for notification of data collection. For example, the QKD module control and management function can notify QKD link-level alert (i.e., notification messages) when a link failure occurs.

The information components that can be provided to the QLM by the QKD module control and management function are as shown in Table 2. In other words, the DataCollectionSubscription_Notify (i.e., a notification message for notification of data collection transmitted by the QKD module control and management function) invoked by the QKD module control and management function may include at least one information component among the information components exemplified in Table 2.

For example, a DataCollectionSubscription_Notify (i.e., a notification message for notification of data collection) may include an information component for an operation type (TypeOperation) and an information component for a correlation identifier (Correlation Identifier). In the case of the example in FIG. 2, TypeOperation may indicate fault management. In addition, in the case of the example in FIG. 2, Correlation Identifier may uniquely indicate the correlation between the QLM and the QKD module control and management functions.

In addition, DataCollectionSubscription_Notify (i.e., the notification message for notification of data collection) may optionally include an event notification (EventNotify). Here, EventNotify may indicate additional QKD link diagnostic information at this step. In this case, steps 3 and 4 described below may be omitted.

3. The QLM determines an initiation of QKD link diagnosis.

4. The QLM can transmit a QKD link diagnosis request message to the QKD module control and management function if necessary. In this case, the QKD module control and management function can report additional QKD link diagnosis information to QLM (via MQ reference point).

5. The QLM analyzes QKD link diagnosis information. That is, the QLM determines whether a QKD link is failed by analyzing d from the QKD module control and management function (i.e. QKD link diagnosis information).

6. The QLM reports the QKD link status to the XIMO based on the QKD link diagnosis information. That is, if the QLM determines a QKD link is failed based on the QKD link diagnosis information, it transmits a QKD link failure report message to the XLMO. On the other hand, if the QLM does not determine a QKD link is failed based on the QKD link diagnosis information, the procedure of FIG. 2 is terminated.

7. The XLMO transmits the QKD link failure diagnostic information to the QCLM.

8. The QCLM makes appropriate control decision(s) to deal with the alert. That is, the QCLM determines/generates appropriate control action(s) based on the QKD link failure diagnostic information.

9. The QCLM transmits the control action(s) to the QKDN controller control and management function for necessary actions. That is, the QCLM transmits the QKD link alert control action(s) to the QKDN controller control and management function (via Mc reference point).

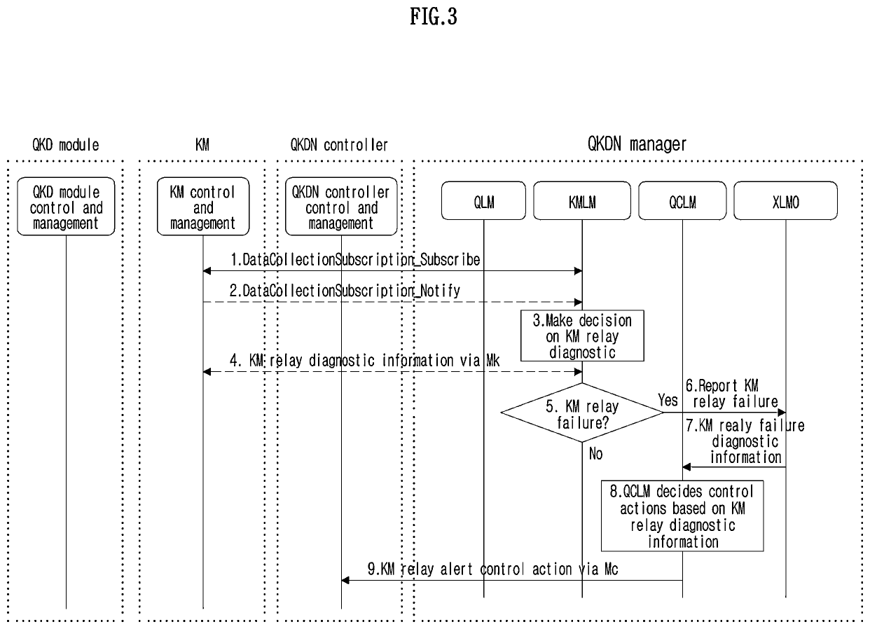

FIG. 3 illustrates a fault management procedure for a key relay failure in a QKDN according to an embodiment of the present invention.

FIG. 3 illustrates a fault management procedure for a key relay failure in KM.

1. The KMLM subscribes to data collection by invoking the DataCollectionSubscription Subscribe operation to the KM module control and management function through the Mk reference point. That is, the KMLM transmits a subscription message for subscribing to data collection to the KM module control and management function. Here, if the subscription is accepted, the KM module control and management function can respond with OK (i.e., respond with an acceptance message for accepting the subscription to data collection).

The information components that can be provided by the KMLM to the KM module control and management function are as shown in Table 2. In other words, DataCollectionSubscription Subscribe invoked by the KMLM (i.e., a subscription message for subscribing to data collection transmitted by the KMLM) can include at least one information component among the information components exemplified in Table 2.

For example, the DataCollectionSubscription Subscribe (i.e., a subscription message for subscribing to data collection) may include an information component for an operation type (TypeOperation) and an information component for a correlation identifier (Correlation Identifier). The information component for an operation type (TypeOperation) indicates a type of management operation. In the case of the example in FIG. 3, the TypeOperation may indicate fault management. In addition, in Table 2, the Correlation Identifier uniquely indicates a correlation between a consumer (KMLM in FIG. 3) and a producer (KM module control and management function in FIG. 3). In the case of the example in FIG. 3, the Correlation Identifier may uniquely indicate the correlation between the KMLM and the KM module control and management function.

2. The KM module control and management function notifies the KMLM with data collection by invoking the DataCollectionSubscription_Notify operation based on the subscription of data collection in step 1. That is, the KM module control and management function transmits a notification message to the KMLM for notification of data collection. For example, the KM module control and management function can notify KM relay alert (i.e., notification messages) when a KM failure occurs.

The information components that can be provided to the KMLM by the KM module control and management function are as shown in Table 2. In other words, the DataCollectionSubscription_Notify (i.e., a notification message for notification of data collection transmitted by the KM module control and management function) invoked by the KM module control and management function may include at least one information component among the information components exemplified in Table 2.

For example, a DataCollectionSubscription_Notify (i.e., a notification message for notification of data collection) may include an information component for an operation type (TypeOperation) and an information component for a correlation identifier (Correlation Identifier). In the case of the example in FIG. 3, TypeOperation may indicate fault management. In addition, in the case of the example in FIG. 3, Correlation Identifier may uniquely indicate the correlation between the KMLM and the KM module control and management functions.

In addition, DataCollectionSubscription_Notify (i.e., the notification message for notification of data collection) may optionally include an event notification (EventNotify). Here, EventNotify may indicate additional KM relay diagnostic information at this step. In this case, steps 3 and 4 described below may be omitted.

3. The KMLM determines an initiation of KM relay diagnosis.

4. The KMLM can optionally transmit a KM relay diagnosis request message to the KM module control and management function. In this case, the KM module control and management function can report KM relay diagnosis information to the KMLM if necessary (via Mk reference point).

5. The KMLM analyzes KM relay diagnosis information and checks whether the failure is related to key relay. That is, the KMLM determines whether KM relay failure occurs by analyzing data collected from KM module control and management function (i.e. KM relay diagnosis information).

6. The KMLM reports the key relay failure in the KM to the XLMO based on the KM relay diagnostic information. That is, if the KMLM determines that KM relay failure has occurred based on the KM relay diagnostic information, it transmits a report message about KM relay failure to the XIMO. On the other hand, if the KMLM does not determine that KM relay failure has occurred based on the KM relay diagnostic information, the procedure of FIG. 3 is terminated.

7. The XIMO sends the KM relay failure diagnostic information to the QCLM.

8. The QCLM makes appropriate control decision(s) to deal with the alert. That is, the QCLM determines/generates appropriate control action(s) based on the KM relay diagnostic information.

9. The QCLM transmits control action(s) to the QKDN controller control and management function for necessary actions. That is, the QCLM sends the KM relay alert control action(s) to the QKDN controller control and management function (via Mc reference point).

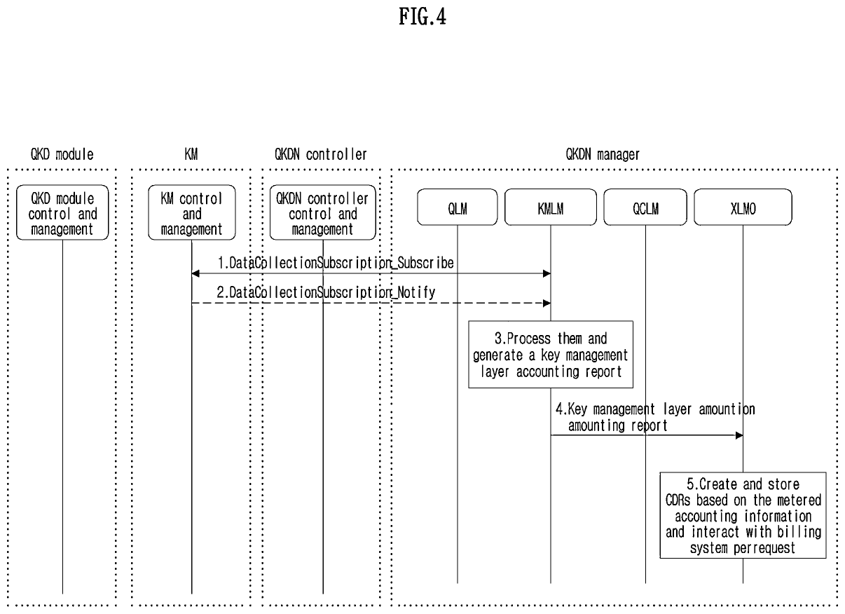

FIG. 4 illustrates an accounting management procedure in a QKDN according to an embodiment of the present invention.

1. The KMLM subscribes to data collection by invoking the DataCollectionSubscription Subscribe operation to the KM module control and management function through the Mk reference point. That is, the KMLM transmits a subscription message for subscribing to data collection to the KM module control and management function. Here, if the subscription is accepted, the KM module control and management function can respond with OK (i.e., respond with an acceptance message for accepting the subscription to data collection).

The information components that can be provided by the KMLM to the KM module control and management function are as shown in Table 2. In other words, DataCollectionSubscription Subscribe invoked by the KMLM (i.e., a subscription message for subscribing to data collection transmitted by the KMLM) can include at least one information component among the information components exemplified in Table 2.

For example, the DataCollectionSubscription Subscribe (i.e., a subscription message for subscribing to data collection) may include an information component for an operation type (TypeOperation) and an information component for a correlation identifier (Correlation Identifier). The information component for an operation type (TypeOperation) indicates a type of management operation. In the case of the example in FIG. 4, the TypeOperation may indicate accounting management. In addition, in Table 2, the Correlation Identifier uniquely indicates a correlation between a consumer (KMLM in FIG. 4) and a producer (KM module control and management function in FIG. 4). In the case of the example in FIG. 4, the correlation identifier may uniquely indicate the correlation between the KMLM and the KM module control and management function.

2. The KM module control and management function notifies the KMLM with data collection by invoking the DataCollectionSubscription_Notify operation based on the subscription of data collection in step 1. That is, the KM module control and management function transmits a notification message to the KMLM for notification of data collection.

The information components that can be provided to the KMLM by the KM module control and management function are as shown in Table 2. In other words, the DataCollectionSubscription_Notify (i.e., a notification message for notification of data collection transmitted by the KM module control and management function) invoked by the KM module control and management function may include at least one information component among the information components exemplified in Table 2.

For example, a DataCollectionSubscription_Notify (i.e., a notification message for notification data collection) may include an information component for an operation type (TypeOperation) and an information component for a correlation identifier (Correlation Identifier). In the case of the example in FIG. 4, TypeOperation may indicate accounting management. In addition, in the case of the example in FIG. 4, Correlation Identifier may uniquely indicate the correlation between the KMLM and the KM module control and management functions.

In addition, DataCollectionSubscription_Notify (i.e., the notification message for notification of data collection) may optionally include an event notification (EventNotify). Here, EventNotify may represent accounting information at this step.

3. The KMLM processes the metered accounting information and generates a report (i.e., key management layer accounting report).

4. The KMLM sends the report (i.e., key management layer accounting report) to the XLMO for additional charging process. That is, the KMLM analyzes the collected data (i.e., metered accounting information) and sends a report message to the XLMO for additional charging process.

5. The XIMO generates and stores a charging data record (CDR) based on the metered key management layer accounting report, and interacts with the charging system when requested.

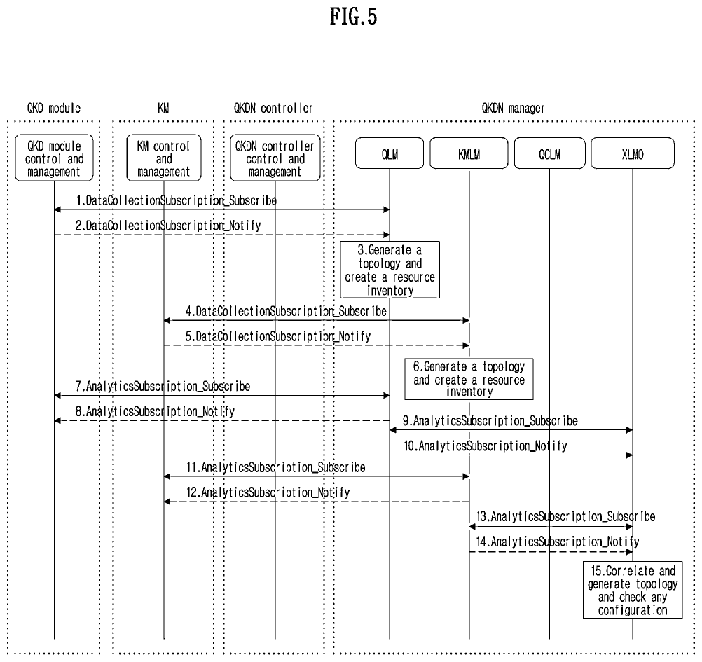

FIG. 5 illustrates a configuration management procedure in a QKDN according to an embodiment of the present invention.

1. The QLM subscribes to data collection by invoking the DataCollectionSubscription Subscribe operation to the QKD module control and management function through the Mq reference point. That is, the QLM transmits a subscription message for subscribing to data collection to the QKD module control and management function. Here, if the subscription is accepted, the QKD module control and management function can respond with OK (i.e., respond with an acceptance message for accepting the subscription to data collection).

The information components that can be provided by the QLM to the QKD module control and management function are as shown in Table 2. In other words, DataCollectionSubscription Subscribe invoked by the QLM (i.e., a subscription message for subscribing to data collection transmitted by the QLM) can include at least one information component among the information components exemplified in Table 2.

For example, the DataCollectionSubscription Subscribe (i.e., a subscription message for subscribing to data collection) may include an information component for an operation type (TypeOperation) and an information component for a correlation identifier (Correlation Identifier). The information component for an operation type (TypeOperation) indicates a type of management operation. In the case of the example in FIG. 5, the TypeOperation may indicate configuration. In addition, in Table 2, the Correlation Identifier uniquely indicates a correlation between a consumer (QLM in FIG. 5) and a producer (QKD module control and management function in FIG. 5). In the case of the example in FIG. 5, the Correlation Identifier may uniquely indicate the correlation between the QLM and the QKD module control and management function.

2. The QKD module control and management function notifies the QLM with data collection by invoking the DataCollectionSubscription_Notify operation based on the subscription of data collection in step 1. That is, the QKD module control and management function transmits a notification message to the QLM for notification of data collection. The information components that can be provided to the QLM by the QKD module control and management function are as shown in Table 2. In other words, the DataCollectionSubscription_Notify (i.e., a notification message for notification of data collection transmitted by the QKD module control and management function) invoked by the QKD module control and management function may include at least one information component among the information components exemplified in Table 2.

For example, a DataCollectionSubscription_Notify (i.e., a notification message for notification of data collection) may include an information component for an operation type (TypeOperation) and an information component for a correlation identifier (Correlation Identifier). In the case of the example in FIG. 5, TypeOperation may indicate configuration. In addition, in the case of the example in FIG. 5, Correlation Identifier may uniquely indicate the correlation between the QLM and the QKD module control and management functions.

3. The QLM generates a quantum layer topology based on the collected data and generates a quantum layer resource inventory. The QLM updates the analysis report including what have been done.

In steps 4 to 6, the KMLM performs the same procedure for configuration management as the OLM performs in steps 1 to 3.

That is, the KMLM generates a key management layer topology and generates a key management layer resource inventory. The KMLM updates the analysis report including what have been done.

7-8. The QLM notifies the QKD module control and management functions of the analytics report by invoking the AnalyticsSubscription Notify operation based on the subscription in step 7. Here, it is assumed that the subscription is completed before the notification is started.

Specifically, the QKD module control and management function subscribes to analytics reports by invoking the AnalyticsSubscription Subscribe operation to the QLM. That is, the QKD module control and management function transmits a subscription message for subscribing to analytics reports to the QLM. Here, if the subscription is accepted, the QLM can respond with OK (i.e., respond with an acceptance message for accepting the subscription to analytics reports).

The information components that can be provided to QLM by the QKD module control and management function are as shown in Table 3. In other words, the AnalyticsSubscription Subscribe (i.e., a subscription message for subscribing to an analysis report transmitted by the QKD module control and management function) invoked by the QKD module control and management function may include at least one information component among the information components exemplified in Table 3.

For example, an AnalyticsSubscription Subscribe (i.e., a subscription message for subscribing to analytics reports) may include an information component for an operation type (TypeOperation) and an information component for a correlation identifier (Correlation Identifier). The information component for an operation type (TypeOperation) indicates a type of management operation. In the case of the example in FIG. 5, the TypeOperation may indicate configuration. In addition, in Table 3, the Correlation Identifier uniquely indicates a correlation between a consumer (QKD module control and management function in FIG. 5) and a producer (QLM in FIG. 5). In the case of the example in FIG. 5, the Correlation Identifier may uniquely indicate the correlation between the QKD module control and management function and QLM.

Table 3 illustrates the information elements for an AnalyticsSubscription operation.

TABLE 3

| Information | | |
|---|---|---|
| component | Description | Example |
| Consumer | A unique identifier for a function of | QKDN control, |
| identifier | requesting performance management | key management |
| | operation (e.g., | layer, quantum |
| | AnalyticsSubscription_Subscribe). | layer, XLMO |
| Producer | A unique identifier for a function of | QCLM, KMLM, |
| identifier | responding performance management | QLM |
| | operation (e.g., | |
| | AnalyticsSubscription_Notify). | |
| Globally unique | A set of IP address information used for | QKDN control, |
| IP address | locating the network in which each layer | key management |
| information | control and management function is | layer, quantum |
| (Optional) | requesting the management operations. | layer |
| Unique IP | The IP address for identifying each layer | QCLM, KMLM |
| address | control and management function. | QLM |
| Address realm | The addressing domain of the IP address | |
| | (e.g., Subnet prefix or VPN ID) | |
| Management | A layer for operating performance | QKDN control, |
| operation layer | management | key management |
| | | layer, quantum |
| | | layer |
| Management | The indication of the importance of a | QCLM, KMLM, |
| operation | management operation request. It can be | QLM |
| request priority | used for processing simultaneous | |
| (Optional) | requests by each layer management | |
| | functional component (QCLM, KMLM, & QLM) | |
| | based on the priority level. | |
| TypeNotify | The indication of the type of notifying | QKDN control, |
| (Optional) | an event (e.g., time interval, | key management |
| | periodicity, maximum number, minimum | layer, quantum |
| | number, etc.). | layer, XLMO |
| | It is an information component of | |
| | AnalyticsSubscription_Subscribe. | |
| TypeOperation | The indication of the type of the | QKDN control, |
| | management operation (e.g., | key management |
| | configuration, performance, security). | layer, quantum |
| | It is an information component of | layer, XLMO |
| | AnalyticsSubscription_Subscribe. | |
| Management | Indication of the result for a management | QCLM, KMLM, |
| operation | operation request. | QLM |
| request result | | |
| Correlation | A unique identifier for correlation | QCLM, KMLM, |
| Identifier | between a consumer and a producer. | QLM |
| AnalyticsNotify | Allows each layer to send notifications | QCLM, KMLM, |
| | to the layer specific management support | QLM |
| | functional component in QKDN manager for | |
| | analytics that may need to take an | |
| | appropriate action for requested | |
| | management operations. | |
| | It is an information component of | |
| | AnalyticsSubscription_Notify. | |

Then, the QLM notifies the QKD module control and management function with the analysis report by invoking the AnalyticsSubscription Notify operation based on the subscription in step 7. That is, the QLM sends a notification message to the QKD module control and management function for notification of the analysis report.

The information components that can be provided to the QKD module control and management functions by the QLM are as shown in Table 3. In other words, the AnalyticsSubscription Notify invoked by the QLM (i.e., a notification message for notification of an analytics report transmitted by the QLM) may include at least one information component among the information components exemplified in Table 3.

For example, an AnalyticsSubscription Notify (i.e., a notification message for notifying an analytics report) may include an information component for an operation type (TypeOperation) and an information component for a correlation identifier (Correlation Identifier). In the example of FIG. 5, TypeOperation may indicate a configuration. In addition, in the example of FIG. 5, the Correlation Identifier may uniquely indicate a correlation between the QLM and the QKD module control and management functions.

9-10. The QLM also performs the same procedure as steps 7-8 for the XLMO, which is depends on a decision of the QLM.

Specifically, the XLMO subscribes to analytics reports by invoking the AnalyticsSubscription Subscribe operation to the QLM. That is, the XLMO transmits a subscription message to the QLM for subscribing to analytics reports. Here, if the subscription is accepted, the OLM can respond with OK (i.e., respond with an acceptance message for accepting the subscription to analytics reports).

The information components that can be provided to the QLM by the XLMO are as shown in Table 3. In other words, the AnalyticsSubscription Subscribe invoked by XIMO (i.e., a subscription message for subscribing to analysis reports transmitted by XLMO) can include at least one information component among the information components exemplified in Table 3.

For example, an AnalyticsSubscription Subscribe (i.e., a subscription message for subscribing to analytics reports) may include an information component for an operation type (TypeOperation) and an information component for a correlation identifier (Correlation Identifier). The information component for an operation type (TypeOperation) indicates the type of management operation. In the case of the example in FIG. 5, the TypeOperation may indicate configuration. In addition, in Table 3, the information component for a correlation identifier (Correlation Identifier) uniquely indicates a correlation between a consumer (XLMO in FIG. 5) and a producer (QLM in FIG. 5). In the case of the example in FIG. 5, the Correlation Identifier may uniquely indicate a correlation between the XLMO and the QLM.

Then, the QLM notifies the XLMO with the analytics report by invoking the AnalyticsSubscription Notify operation based on the subscription in step 9. That is, the QLM sends a notification message to the XIMO for notification of the analytics report.

The information components that can be provided to the XIMO by the QLM are as shown in Table 3. In other words, the AnalyticsSubscription Notify called by the QLM (i.e., a notification message for notification of an analytics report transmitted by QLM) can include at least one information component among the information components exemplified in Table 3.

For example, an AnalyticsSubscription Notify (i.e., a notification message for notifying an analytics report) may include an information component for an operation type (TypeOperation) and an information component for a correlation identifier (Correlation Identifier). In the example of FIG. 5, TypeOperation may indicate a configuration. In addition, in the example of FIG. 5, the Correlation Identifier may uniquely indicate a correlation between the QLM and the XLMO.

In steps 11 to 14, the KMLM performs the same procedure for configuration management as the QLM performs in steps 7 to 10.

15. The XLMO correlates the received quantum layer topology information with the key management layer topology information to generate the entire QKDN topology and checks for any configuration errors.

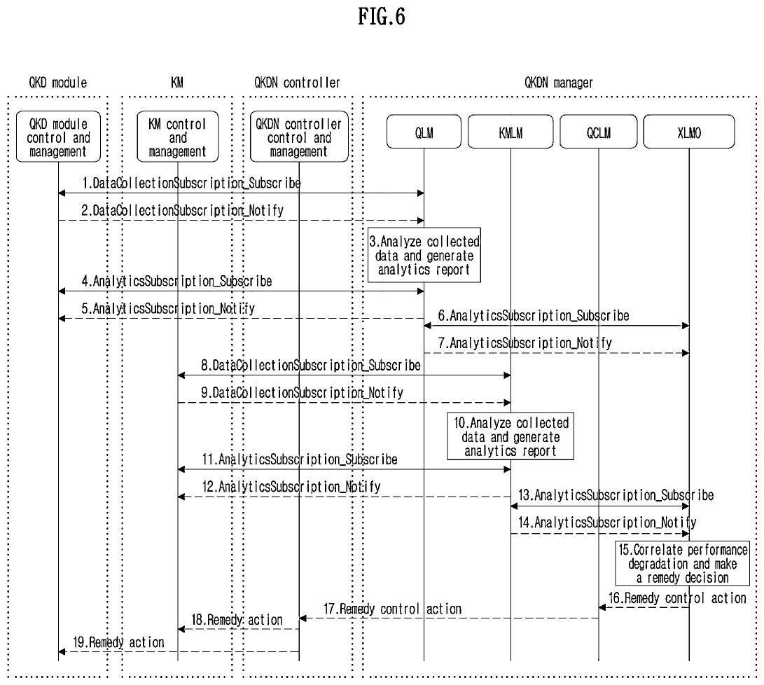

FIG. 6 illustrates a performance management procedure in a QKDN according to an embodiment of the present invention.

1. The QLM subscribes to data collection by invoking the DataCollectionSubscription Subscribe operation to the QKD module control and management function through the Mq reference point. That is, the QLM transmits a subscription message for subscribing to data collection to the QKD module control and management function. Here, if the subscription is accepted, the QKD module control and management function can respond with OK (i.e., respond with an acceptance message for accepting the subscription to data collection).

The information components that can be provided by the QLM to the QKD module control and management function are as shown in Table 2. In other words,

DataCollectionSubscription Subscribe invoked by the QLM (i.e., a subscription message for subscribing to data collection transmitted by the QLM) can include at least one information component among the information components exemplified in Table 2.

For example, the DataCollectionSubscription Subscribe (i.e., a subscription message for subscribing to data collection) may include an information component for an operation type (TypeOperation) and an information component for a correlation identifier (Correlation Identifier). The information component for an operation type (TypeOperation) indicates a type of management operation. In the case of the example in FIG. 6, the TypeOperation may indicate performance. In addition, in Table 2, the Correlation Identifier uniquely indicates correlation between a consumer (QLM in FIG. 6) and a producer (QKD module control and management function in FIG. 6). In the case of the example in FIG. 6, the Correlation Identifier may uniquely indicate the correlation between the QLM and the QKD module control and management function.

2. The QKD module control and management function notifies the QLM with data collection by invoking the DataCollectionSubscription_Notify operation based on the subscription of data collection in step 1. That is, the QKD module control and management function transmits a notification message to the QLM for notification of data collection.

The information components that can be provided to the QLM by the QKD module control and management function are as shown in Table 2. In other words, the DataCollectionSubscription_Notify (i.e., a notification message for notification of data collection transmitted by the QKD module control and management function) invoked by the QKD module control and management function may include at least one information component among the information components exemplified in Table 2.

For example, a DataCollectionSubscription_Notify (i.e., a notification message for notification of data collection) may include an information component for an operation type (TypeOperation) and an information component for a correlation identifier (Correlation Identifier). In the case of the example in FIG. 6, TypeOperation may indicate performance. In addition, in the case of the example in FIG. 6, Correlation Identifier may uniquely indicate the correlation between the QLM and the QKD module control and management functions.

3. The QLM analyzes the collected data (i.e., performance information), generates an analysis report, and stores it.

4-5. The QLM notifies the QKD module control and management function with the analytics report by invoking the AnalyticsSubscription Notify operation based on the subscription in step 4 from the QKD module control and management function. Here, it is assumed that the subscription is completed before the notification is started.

Specifically, the QKD module control and management function subscribes to analytics reports by invoking the AnalyticsSubscription Subscribe operation to the QLM. That is, the QKD module control and management function transmits a subscription message for subscribing to analytics reports to the QLM. Here, if the subscription is accepted, the QLM can respond with OK (i.e., respond with an acceptance message for accepting the subscription to analytics reports).

The information components that can be provided to QLM by the QKD module control and management function are as shown in Table 3. In other words, the AnalyticsSubscription Subscribe (i.e., a subscription message for subscribing to an analysis report transmitted by the QKD module control and management function) invoked by the QKD module control and management function may include at least one information component among the information components exemplified in Table 3.

For example, an AnalyticsSubscription Subscribe (i.e., a subscription message for subscribing to analytics reports) may include an information component for an operation type (TypeOperation) and an information component for a correlation identifier (Correlation Identifier). The information component for an operation type (TypeOperation) indicates a type of management operation. In the case of the example in FIG. 6, the TypeOperation may indicate performance. In addition, in Table 3, the Correlation Identifier uniquely indicates a correlation between a consumer (QKD module control and management function in FIG. 6) and a producer (QLM in FIG. 6). In the case of the example in FIG. 6, the Correlation Identifier may uniquely indicate the correlation between the QKD module control and management function and QLM.

Then, the QLM notifies the QKD module control and management function with the analysis report by invoking the AnalyticsSubscription Notify operation based on the subscription in step 4. That is, the QLM sends a notification message to the QKD module control and management function for notification of the analysis report.

The information components that can be provided to the QKD module control and management functions by the QLM are as shown in Table 3. In other words, the AnalyticsSubscription Notify invoked by the QLM (i.e., a notification message for notification of an analytics report transmitted by the QLM) may include at least one information component among the information components exemplified in Table 3.

For example, an AnalyticsSubscription Notify (i.e., a notification message for notifying an analytics report) may include an information component for an operation type (TypeOperation) and an information component for a correlation identifier (Correlation Identifier). In the example of FIG. 6, TypeOperation may indicate performance. In addition, in the example of FIG. 6, the Correlation Identifier may uniquely indicate a correlation between the QLM and the QKD module control and management functions.

6-7. The QLM also performs the same procedure as steps 4-5 for the XLMO, which is depends on a decision of the QLM.

Specifically, the XLMO subscribes to analytics reports by invoking the AnalyticsSubscription Subscribe operation to the QLM. That is, the XLMO transmits a subscription message to the QLM for subscribing to analytics reports. Here, if the subscription is accepted, the OLM can respond with OK (i.e., respond with an acceptance message for accepting the subscription to analytics reports).

The information components that can be provided to the QLM by the XLMO are as shown in Table 3. In other words, the AnalyticsSubscription Subscribe invoked by XLMO (i.e., a subscription message for subscribing to analysis reports transmitted by XLMO) can include at least one information component among the information components exemplified in Table 3.

For example, an AnalyticsSubscription Subscribe (i.e., a subscription message for subscribing to analytics reports) may include an information component for an operation type (TypeOperation) and an information n component for a correlation identifier (Correlation Identifier). The information component for an operation type (TypeOperation) indicates the type of management operation. In the case of the example in FIG. 6, the TypeOperation may indicate performance. In addition, in Table 3, the information component for a correlation identifier (Correlation Identifier) uniquely indicates a correlation between a consumer (XLMO in FIG. 6) and a producer (QLM in FIG. 6). In the case of the example in FIG. 6, the Correlation Identifier may uniquely indicate a correlation between the XIMO and the QLM.

In steps 8 to 14, the KMLM performs the same procedure for key management layer performance management as the QLM performs in steps 1 to 7.

Here, in FIG. 6, for convenience of explanation, the case where the data collection procedure is performed first in the QLM is exemplified, but the order of the data collection procedure may be changed. That is, it may be performed first in the KMLM, or it may be performed in parallel.

15. The XLMO correlates the performance information of the quantum layer with the performance information of the key management layer to identify cross-layer performance degradation issues. Then, the XIMO generates remedial action policies for both the quantum layer and the key management layer.

16. The XLMO transmits the remedial control action to the QCLM.

17. The QCLM forwards the remedial control action to the QKDN controller control and management function. In addition, the XIMO can also optionally transmit the remedial action if necessary to resolve the performance degradation issue.

18. The QKDN controller control and management function forwards the remedial control action to the QKD module control and management function.

19. The QKDN controller control and management function also forwards the remedial control action to the KM control and management function.

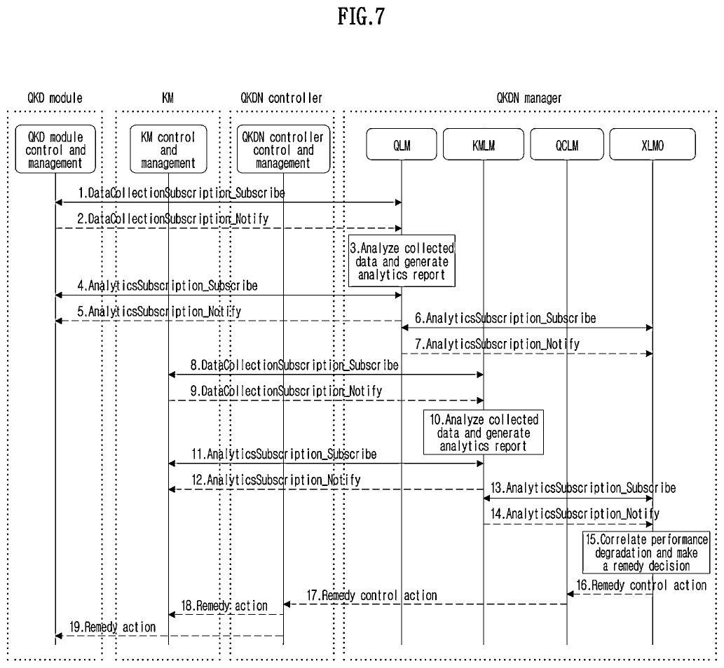

FIG. 7 illustrates a security management procedure in a QKDN according to an embodiment of the present invention.

1. The QLM subscribes to data collection by invoking the DataCollectionSubscription Subscribe operation to the QKD module control and management function through the Mq reference point. That is, the QLM transmits a subscription message for subscribing to data collection to the QKD module control and management function. Here, if the subscription is accepted, the QKD module control and management function can respond with OK (i.e., respond with an acceptance message for accepting the subscription to data collection).

The information components that can be provided by the QLM to the QKD module control and management function are as shown in Table 2. In other words, DataCollectionSubscription Subscribe invoked by the QLM (i.e., a subscription message for subscribing to data collection transmitted by the QLM) can include at least one information component among the information components exemplified in Table 2.

For example, the DataCollectionSubscription Subscribe (i.e., a subscription message for subscribing to data collection) may include an information component for an operation type (TypeOperation) and an information component for a correlation identifier (Correlation Identifier). The information component for an operation type (TypeOperation) indicates a type of management operation. In the case of the example in FIG. 7, the TypeOperation may indicate security. In addition, in Table 2, the information component for an correlation identifier (Correlation Identifier) uniquely indicates a correlation between a consumer (QLM in FIG. 7) and a producer (QKD module control and management function in FIG. 7). In the case of the example in FIG. 7, the Correlation Identifier may uniquely indicate the correlation between the QLM and the QKD module control and management function.

2. The QKD module control and management function notifies the QLM with data collection by invoking the DataCollectionSubscription_Notify operation based on the subscription of data collection in step 1. That is, the QKD module control and management function transmits a notification message to the QLM for notification of data collection. The information components that can be provided to the QLM by the QKD module control and management function are as shown in Table 2. In other words, the DataCollectionSubscription_Notify (i.e., a notification message for notification of data collection transmitted by the QKD module control and management function) invoked by the QKD module control and management function may include at least one information component among the information components exemplified in Table 2.

For example, a DataCollectionSubscription_Notify (i.e., a notification message for notification of data collection) may include an information component for an operation type (TypeOperation) and an information component for a correlation identifier (Correlation Identifier). In the case of the example in FIG. 7, TypeOperation may indicate security. In addition, in the case of the example in FIG. 7, Correlation Identifier may uniquely indicate the correlation between the QLM and the QKD module control and management functions.

3. The QLM analyzes the collected data (i.e., security information), generates an analysis report, and stores it.

4-5. The QLM notifies the QKD module control and management function with the analytics report by invoking the AnalyticsSubscription Notify operation based on the subscription in step 4 from the QKD module control and management function. Here, it is assumed that the subscription is completed before the notification is started.

Specifically, the QKD module control and management function subscribes to analytics reports by invoking the AnalyticsSubscription Subscribe operation to the QLM. That is, the QKD module control and management function transmits a subscription message for subscribing to analytics reports to the QLM. Here, if the subscription is accepted, the QLM can respond with OK (i.e., respond with an acceptance message for accepting the subscription to analytics reports).

The information components that can be provided to QLM by the QKD module control and management function are as shown in Table 3. In other words, the AnalyticsSubscription Subscribe (i.e., a subscription message for subscribing to an analysis report transmitted by the QKD module control and management function) invoked by the QKD module control and management function may include at least one information component among the information components exemplified in Table 3.

For example, an AnalyticsSubscription Subscribe (i.e., a subscription message for subscribing to analytics reports) may include an information component for an operation type (TypeOperation) and an information component for a correlation identifier (Correlation Identifier). The information component for an operation type (TypeOperation) indicates a type of management operation. In the case of the example in FIG. 7, the TypeOperation may indicate secirity. In addition, in Table 3, the information component for an correlation identifier (Correlation Identifier) indicates a correlation uniquely between a consumer (QKD module control and management function in FIG. 7) and a producer (QLM in FIG. 7). In the case of the example in FIG. 7, the Correlation Identifier may uniquely indicate the correlation between the QKD module control and management function and QLM.

Then, the QLM notifies the QKD module control and management function with the analysis report by invoking the AnalyticsSubscription Notify operation based on the subscription in step 4. That is, the QLM sends a notification message to the QKD module control and management function for notification of the analysis report.

The information components that can be provided to the QKD module control and management functions by the QLM are as shown in Table 3. In other words, the AnalyticsSubscription Notify invoked by the QLM (i.e., a notification message for notification of an analytics report transmitted by the QLM) may include at least one information component among the information components exemplified in Table 3.

For example, an AnalyticsSubscription Notify (i.e., a notification message for notifying an analytics report) may include an information component for an operation type (TypeOperation) and an information component for a correlation identifier (Correlation Identifier). In the example of FIG. 7, TypeOperation may indicate security. In addition, in the example of FIG. 7, the Correlation Identifier may uniquely indicate a correlation between the QLM and the QKD module control and management functions.

6-7. The QLM also performs the same procedure as steps 4-5 for the XLMO, which is depends on a decision of the QLM.

Specifically, the XLMO subscribes to analytics reports by invoking the AnalyticsSubscription Subscribe operation to the QLM. That is, the XLMO transmits a subscription message to the QLM for subscribing to analytics reports. Here, if the subscription is accepted, the QLM can respond with OK (i.e., respond with an acceptance message for accepting the subscription to analytics reports).

The information components that can be provided to the QLM by the XIMO are as shown in Table 3. In other words, the AnalyticsSubscription Subscribe invoked by XLMO (i.e., a subscription message for subscribing to analysis reports transmitted by XLMO) can include at least one information component among the information components exemplified in Table 3.

For example, an AnalyticsSubscription Subscribe (i.e., a subscription message for subscribing to analytics reports) may include an information component for an operation type (TypeOperation) and an information component for a correlation identifier (Correlation Identifier). The information component for an operation type (TypeOperation) indicates the type of management operation. In the case of the example in FIG. 7, the TypeOperation may indicate security. In addition, in Table 3, the information component for a correlation identifier (Correlation Identifier) uniquely indicates a correlation between a consumer (XLMO in FIG. 7) and a producer (QLM in FIG. 7). In the case of the example in FIG. 7, the Correlation Identifier may uniquely indicate a correlation between the XIMO and the QLM.

In steps 8 to 14 and steps 15 to 21, the KMLM and the QCLM collect security information in terms of key management and QKDN control, respectively, and the KMLM and the QCLM report security analysis in the same way as the QLM performed in steps 1 to 7.

Here, in FIG. 7, for convenience of explanation, the case where the data collection procedure is performed first in the QLM is exemplified, but the order of the data collection procedure may be changed. That is, it may be performed first in the KMLM or first in the QCLM. Alternatively, it may be performed in parallel.

22. The XIMO analyzes security anomalies based on the collected security information and makes decisions on solutions for security anomalies and control policy rules to remedy the anomalies.

23. The XLMO reports security anomaly action policy rules to the QCLM.

24. The QCLM transmits security anomaly action policy rules to the QKDN controller control and management function.

25. The QKDN controller control and management function forwards the remedial action to the control and management function of the QKD module.

26. The QKDN controller control and management function also forwards the remedial action to the control and management function of the KM.

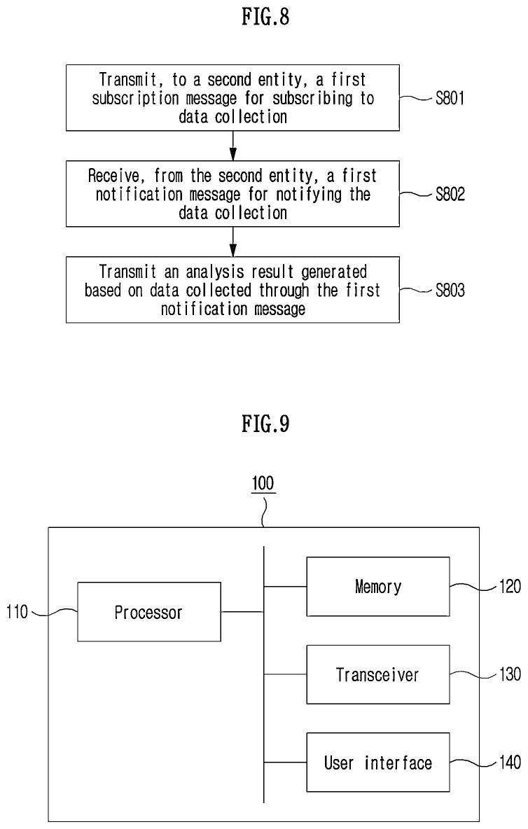

FIG. 8 illustrates a control and management method in a QKDN according to an embodiment of the present invention.

Hereinafter, in the description of the present invention, an entity may refer to an operating entity (i.e., a device or some components within a device) corresponding to one layer or may refer to an operating entity (i.e., a device or some components within a device) performing one function within one layer, in a QKDN architecture of FIG. 1. Alternatively, the entity may refer to an entity (i.e., a device or some component within a device) that comprises multiple layers, or may refer to an entity (i.e., a device or some component within a device) that performs multiple functions within a single layer.

In addition, even if there is no separate description in this document, an entity may mean a device, or may correspond to a component within a device. That is, when an entity performs an action, it can be interpreted that a device (or a device including components) performs an action.

Referring to FIG. 8, a first entity transmits a subscription message (hereinafter referred to as a first subscription message) for subscribing to data collection to a second entity (S801).

Here, the first entity corresponds to a consumer requesting an operation for data collection from the second entity, and may correspond to, for example, the QLM, the KMLM, and the QCLM as exemplified in FIGS. 2 to 6. In addition, the second entity may correspond to a producer responding to an operation for data collection from the first entity, and may correspond to, for example, the QKD module control and management functions and the KM control and management functions as exemplified in FIGS. 2 to 6.

Here, the first subscription message may correspond to the DataCollectionSubscription Subscribe operation exemplified in FIGS. 2 to 6.

In addition, the first subscription message may include one or more information components as exemplified in Table 2. In particular, it may include information on an operation type (i.e., TypeOperation) that indicates a type of management operation and a correlation identifier (i.e., Correlation Identifier) that uniquely indicates a correlation between a first entity and a second entity. For example, the operation type may include fault management, accounting management, configuration management, performance management, security management, etc.

Although not shown in FIG. 8, a first entity may receive an acceptance message from a second entity to accept a subscription to data collection.

A first entity receives a notification message (hereinafter referred to as a first notification message) for notification of data collection from a second entity (S802).

Here, the first notification message may correspond to the DataCollectionSubscription_Notify operation exemplified in FIGS. 2 to 6.

In addition, the first notification message may include one or more information components exemplified in Table 2. In particular, it may include information on an operation type (i.e., TypeOperation) indicating a type of management operation and a correlation identifier (i.e., Correlation Identifier) uniquely indicating a correlation between the first entity and the second entity. For example, the operation type may include fault management, accounting management, configuration management, performance management, security management, etc.

A first entity transmits an analysis result generated based on data collected through a notification message (i.e., a first notification message) (S803).

Here, the first entity can receive a second subscription message for subscribing to an analysis report from the second entity or a third entity, and the first entity can transmit a second notification message for notifying the analysis report to the second entity or the third entity. In this case, the analysis result can be transmitted through the second notification message.

In addition, the second subscription message and the second notification message may include one or more information components as exemplified in Table 3. In particular, they may include information on an operation type (i.e., TypeOperation) and a correlation identifier (i.e., Correlation Identifier). For example, the operation type may include fault management, accounting management, configuration management, performance management, security management, etc.

Here, the third entity may perform a function of orchestrating management for multiple layers, and may be, for example, XLMO.

For example, in case of fault management (i.e., the operation type indicates fault management), the QLM can report the QKD link status to the XIMO by analyzing the data collected from the QKD module control and management function (i.e., the QKD link diagnostic information). Alternatively, the KMLM can report the key relay failure of the KM to the XLMO by analyzing the data collected from the KM module control and management function (i.e., the KM relay diagnostic information). That is, the analysis result can include the link status generated based on the QKD link diagnostic information or the key relay failure generated based on the KM relay diagnostic information.

As another example, in the case of accounting management (i.e., the operation type indicates accounting management), the KMLM can analyze the collected data (i.e., quantitative accounting information) and send a reporting message to the XIMO for additional charging processing. That is, the analysis results can include a report for charging processing generated based on the quantitative accounting information.

As another example, for configuration management (i.e., the operation type indicates configuration management), the QLM/KMLM may generate a quantum layer/key management layer topology based on the collected data, generate a quantum layer/key management layer resource inventory, and send an analysis report including the performed operations to the XLMO. That is, the analysis results may include a report including the topology and resource inventory.

As another example, in the case of performance management (i.e., the operation type indicates performance management), the QLM/KMLM can analyze the collected data (i.e., performance information), generate an analysis report, and send it to the XLMO. That is, the analysis results can include a report generated by analyzing the performance information.

As another example, in the case of security management (i.e., the operation type indicates security management), the QLM/KMLM/QCLM can analyze the collected data (i.e., security information), generate an analysis report, and send it to the XLMO. That is, the analysis result can include a report generated by analyzing the security information.

FIG. 9 is a block diagram of an apparatus for control and management operating in a QKDN according to an embodiment of the present invention.

The apparatus 100 (hereinafter referred to as a first apparatus) may include one or more processors 110, one or more memories 120, one or more transceivers 130, and one or more user interfaces 140. The memory 120 may be included in the processor 110 or may be configured separately. The memory 120 may store instructions that, when executed by the processor 110, cause the first apparatus 100 to perform an operation. The transceiver 130 may transmit and/or receive signals and data that the first apparatus 100 exchanges with other entities. The user interface 140 may receive a user's input regarding the first apparatus 100 or provide an output of the first apparatus 100 to the user. Among the components of the first apparatus 100, components other than the processor 110 and the memory 120 may not be included in some cases, and other components not shown in FIG. 9 may be included in the first apparatus 100.

The processor 110 may be configured to enable the above-described first apparatus 100 to perform methods according to various examples of the present disclosure. Although not shown in FIG. 9, the processor 110 may be configured as a set of modules that perform each method/function proposed in this disclosure. Modules may be configured in hardware and/or software form.

The processor 110 transmits a subscription message (hereinafter referred to as a first subscription message) for subscribing to data collection to a second apparatus. Here, the first apparatus corresponds to a consumer requesting an operation for data collection from the second apparatus, and may correspond to, for example, the QLM, the KMLM, and the QCLM as exemplified in FIGS. 2 to 6. In addition, the second apparatus may correspond to a producer responding to an operation for data collection from the first apparatus, and may correspond to, for example, the QKD module control and management functions and the KM control and management functions as exemplified in FIGS. 2 to 6.

Here, the first subscription message may correspond to the DataCollectionSubscription Subscribe operation exemplified in FIGS. 2 to 6.

In addition, the first subscription message may include one or more information components as exemplified in Table 2. In particular, it may include information on an operation type (i.e., TypeOperation) that indicates a type of management a correlation operation and identifier (i.e., Correlation Identifier) that uniquely indicates a correlation between a first apparatus and a second apparatus. For example, the operation type may include fault management, accounting management, configuration management, performance management, security management, etc.

The processor 110 may receive an acceptance message from a second apparatus to accept a subscription to data collection.

The processor 110 receives a notification message (hereinafter referred to as a first notification message) for notification of data collection from a second apparatus.

Here, the first notification message may correspond to the DataCollectionSubscription_Notify operation exemplified in FIGS. 2 to 6.

In addition, the first notification message may include one or more information components exemplified in Table 2. In particular, it may include information on an operation type (i.e., TypeOperation) indicating a type of management operation and a correlation identifier (i.e., Correlation Identifier) uniquely indicating a correlation between the first apparatus and the second apparatus. For example, the operation type may include fault management, accounting management, configuration management, performance management, security management, etc.

The processor 110 transmits an analysis result generated based on data collected through a notification message (i.e., a first notification message).

Here, the first apparatus can receive a second subscription message for subscribing to an analysis report from the second apparatus or a third apparatus, and the first apparatus can transmit a second notification message for notifying the analysis report to the second apparatus or the third apparatus. In this case, the analysis result can be transmitted through the second notification message.

In addition, the second subscription message and the second notification message may include one or more information components as exemplified in Table 3. In particular, they may include information on an operation type (i.e., TypeOperation) and a correlation identifier (i.e., Correlation Identifier). For example, the operation type may include fault management, accounting management, configuration management, performance management, security management, etc.

Here, the third apparatus may perform a function of orchestrating management for multiple layers, and may be, for example, XLMO.

For example, in case of fault management (i.e., the operation type indicates fault management), the QLM can report the QKD link status to the XLMO by analyzing the data collected from the QKD module control and management function (i.e., the QKD link diagnostic information). Alternatively, the KMLM can report the key relay failure of the KM to the XIMO by analyzing the data collected from the KM module control and management function (i.e., the KM relay diagnostic information). That is, the analysis result can include the link status generated based on the QKD link diagnostic information or the key relay failure generated based on the KM relay diagnostic information.

As another example, in the case of accounting management (i.e., the operation type indicates accounting management), the KMLM can analyze the collected data (i.e., quantitative accounting information) and send a reporting message to the XIMO for additional charging processing. That is, the analysis results can include a report for charging processing generated based on the quantitative accounting information.

As another example, for configuration management (i.e., the operation type indicates configuration management), the QLM/KMLM may generate a quantum layer/key management layer topology based on the collected data, generate a quantum layer/key management layer resource inventory, and send an analysis report including the performed operations to the XLMO. That is, the analysis results may include a report including the topology and resource inventory.

As another example, in the case of performance management (i.e., the operation type indicates performance management), the QLM/KMLM can analyze the collected data (i.e., performance information), generate an analysis report, and send it to the XIMO. That is, the analysis results can include a report generated by analyzing the performance information.

As another example, in the case of security management (i.e., the operation type indicates security management), the QLM/KMLM/QCLM can analyze the collected data (i.e., security information), generate an analysis report, and send it to the XIMO. That is, the analysis result can include a report generated by analyzing the security information. Components described in exemplary embodiments of the present disclosure may be implemented by hardware elements. For example, the hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in exemplary embodiments may be implemented in a combination of hardware and software.

The method according to an embodiment of the present disclosure may be implemented as a program that can be executed by a computer, and the computer program may be recorded in various recording media such as magnetic storage media, optical read media, and digital storage media.

The various technologies described in this disclosure may be implemented as digital electronic circuits or computer hardware, firmware, software, or a combination thereof. The above technologies may be implemented as a computer program product, that is, a computer program tangibly embodied in an information medium (e.g., a machine-readable storage device (e.g., a computer-readable medium) or a data processing device) or a computer program implemented as signals processed by or propagated by a data processing device to cause the operation of the data processing device (e.g., programmable processor, computer, or multiple computers).

Computer program(s) may be written in any form of programming language, including compiled or interpreted languages and may be distributed as a stand-alone program or in any form, including modules, components, subroutines, or other units suitable for use in a computing environment. A computer program may be executed by a single computer or by multiple computers distributed at one site or multiple sites and interconnected by a communications network.

Examples of processors suitable for executing computer programs include general-purpose and special-purpose microprocessors, and one or more processors in digital computers. Typically, a processor receives instructions and data from read-only memory, random access memory, or both. Components of a computer may include at least one processor for executing instructions and one or more memory devices storing instructions and data. Additionally, the computer may include one or more mass storage devices for data storage, such as magnetic, magneto-optical disks, or optical disks, or may be connected to the mass storage devices to receive and/or transmit data. Examples of information media suitable for implementing computer program instructions and data include optical media such as semiconductor memory devices (e.g., magnetic media such as hard disks, floppy disks, and magnetic tapes), compact disk read-only memory (CD-ROM), digital video disk (DVD), etc., magneto-optical media such as floptical disks, and read only memory (ROM), random access memory (RAM), flash memory, erasable programmable ROM (EPROM), electrically erasable programmable ROM (EEPROM), and other known computer-readable media. Processors and memories can be supplemented or integrated by special-purpose logic circuits.

A processor may run an operating system (OS) and one or more software applications that run on the OS. The processor device may also access, store, manipulate, process and generate data in response to software execution. For simplicity, the processor device is described in the singular, but those skilled in the art will understand that the processor device may include a plurality of processing elements and/or various types of processing elements. For example, a processor device may include a plurality of processors or a processor and a controller. Additionally, different processing structures, such as parallel processors, may be configured. Additionally, computer-readable media refers to all media that a computer can access, and may include both computer storage media and transmission media.

Although this disclosure includes detailed descriptions of various detailed implementation examples, the details should not be construed as limiting the invention or scope of the claims proposed in this disclosure, but rather illustrating features of specific exemplary embodiments.

Features individually described in exemplary embodiments in this disclosure may be implemented by a single exemplary embodiment. Conversely, various features described in this disclosure with respect to a single exemplary embodiment may be implemented by a combination or appropriate sub-combination of a plurality of exemplary embodiments. Furthermore, in the present disclosure, the features may operate by a specific combination, and the combination may initially be described as claimed, however, in some cases, one or more features may be excluded from the claimed combination, or claimed combinations may be modified in the form of sub-combinations or modifications of sub-combinations.

Similarly, even if operations are depicted in a specific order in the drawings, it should not be understood that execution of the operations in a specific order or sequence is necessary, or that performance of all operations is required to obtain a desired result. In certain cases, multitasking and parallel processing can be useful. Additionally, it should not be understood that the various device components in all exemplary embodiments are necessarily separate, and the above-described program components and devices may be packaged in a single software product or multiple software products.

The exemplary embodiments disclosed herein are illustrative only and are not intended to limit the scope of the disclosure. Those skilled in the art will recognize that various modifications may be made to the exemplary embodiments without departing from the scope of the claims and their equivalents.

Accordingly, this disclosure is intended to include all other substitutions, modifications and changes that fall within the scope of the following claims.

What is claimed is:

1. A method performed by a first apparatus in a quantum key distribution network (QKDN), the method comprising:
transmitting, to a second apparatus, a first subscription message for subscribing to data collection;
receiving, from the second apparatus, a first notification message for notifying the data collection; and
transmitting an analysis result generated based on data collected through the first notification message,
wherein the first subscription message and the first notification message include information on an operation type indicating a type of a management operation and a correlation identifier uniquely indicating a correlation between the first apparatus and the second apparatus.

2. The method of claim 1, further comprising:
receiving an acceptance message for accepting a subscription to the data collection from the second apparatus.

3. The method of claim 1, further comprising:
receiving, from the second apparatus or a third apparatus, a second subscription message for subscribing to an analysis report; and
transmitting, to the second apparatus or the third apparatus, a second notification message for notifying of the analysis report,
wherein the analysis result is transmitted through the second notification message.

4. The method of claim 3, wherein the second subscription message and the second notification message include information on an operation type and a correlation identifier.

5. The method of claim 3, wherein the third apparatus performs a function of orchestrating management for multiple layers.

6. The method of claim 1, wherein when the operation type indicates fault management, the analysis result includes a link status generated based on quantum key distribution (QKD) link diagnostic information or a key relay fault generated based on key manage (KM) relay diagnostic information.

7. The method of claim 1, wherein when the operation type indicates accounting management, the analysis result includes a report for a charging process generated based on metered accounting information.

8. The method of claim 1, wherein when the operation type indicates configuration management, the analysis result includes a report including a topology and resource inventory.

9. The method of claim 1, wherein when the operation type indicates performance management, the analysis result includes a report generated by analyzing performance information.

10. The method of claim 1, wherein when the operation type indicates security management, the analysis result includes a report generated by analyzing security information.

11. A first apparatus operating in a quantum key distribution network (QKDN), the apparatus comprising:
at least one processor; and
at least one memory operably connected to the at least one processor and storing instructions that, when executed by the one or more processors, cause the apparatus to perform operations comprising:
transmitting, to a second apparatus, a first subscription message for subscribing to data collection;
receiving, from the second apparatus, a first notification message for notifying the data collection; and
transmitting an analysis result generated based on data collected through the first notification message,
wherein the first subscription message and the first notification message include information on an operation type indicating a type of a management operation and a correlation identifier uniquely indicating a correlation between the first apparatus and the second apparatus.

12. The first apparatus of claim 11, the operations further comprising:
receiving an acceptance message for accepting a subscription to the data collection from the second apparatus.

13. The first apparatus of claim 11, the operations further comprising:
receiving, from the second apparatus or a third apparatus, a second subscription message for subscribing to an analysis report; and
transmitting, to the second apparatus or the third apparatus, a second notification message for notifying of the analysis report,
wherein the analysis result is transmitted through the second notification message.

14. The first apparatus of claim 13, wherein the second subscription message and the second notification message include information on an operation type and a correlation identifier.

15. The first apparatus of claim 11, wherein when the operation type indicates fault management, the analysis result includes a link status generated based on quantum key distribution (QKD) link diagnostic information or a key relay fault generated based on key manager (KM) relay diagnostic information.

16. The first apparatus of claim 11, wherein when the operation type indicates accounting management, the analysis result includes a report for a charging process generated based on metered accounting information.

17. The first apparatus of claim 11, wherein when the operation type indicates configuration management, the analysis result includes a report including a topology and resource inventory.

18. The first apparatus of claim 11, wherein when the operation type indicates performance management, the analysis result includes report generated by analyzing performance information.

19. The first apparatus of claim 11, wherein when the operation type indicates security management, the analysis result includes a report generated by analyzing security information.

20. At least one non-transitory computer-readable medium storing at least one instruction, wherein the at least one instruction executable by at least one processor controls a first apparatus operating in a quantum key distribution network (QKDN) to:
transmit, to a second apparatus, a first subscription message for subscribing to data collection;
receive, from the second apparatus, a first notification message for notifying the data collection; and
transmit an analysis result generated based on data collected through the first notification message,
wherein the first subscription message and the first notification message include information on an operation type indicating a type of a management operation and a correlation identifier uniquely indicating a correlation between the first apparatus and the second apparatus.
